(19) United States
(12) Patent Application Publication
(10) Pub. No.: US 2012/0249638 A1
(43) Pub. Date: Oct. 4, 2012

(54) LIQUID EJECTING APPARATUS AND CONTROL METHOD THEREOF

(75) Inventors: Koji TAKANO, Shiojiri (JP); Kinya OZAWA, Shiojiri (JP)

(73) Assignee: SEIKO EPSON CORPORATION, Tokyo (JP)

(21) Appl. No.: 13/431,415

(22) Filed: Mar. 27, 2012

(30) Foreign Application Priority Data
Mar. 29, 2011 (JP) 2011-071863

(51) Int. Cl. B41J 29/38

(52) U.S. Cl. 347/10

(57) ABSTRACT

A liquid ejecting apparatus includes: a liquid ejecting head, having a pressure chamber filled with a liquid, and a pressure generation element that causes the pressure of the liquid within the pressure chamber to fluctuate that ejects the liquid from a nozzle based on the pressure fluctuation in the liquid within the pressure chamber; a driving waveform generation unit that generates a driving waveform for ejects the liquid; a control unit that causes the liquid ejecting head to execute a flushing operation that discharges the liquid within the pressure chamber; and a residual vibration detection unit that detects a residual vibration in the liquid within the pressure chamber. The control unit calculates a characteristic value in accordance with a characteristic of the liquid based on the residual vibration produced by the flushing operation, and corrects the driving waveform based on the characteristic value.

### BACKGROUND

1. Technical Field

The present invention relates to techniques for ejecting a liquid such as ink.

2. Related Art

Liquid ejection techniques in which a liquid (such as ink) within a pressure chamber is pressurized by a pressure generation element such as a piezoelectric vibrator, a heating element, or the like and ejected from a nozzle have been proposed in the past. Because the ejection characteristics (ejection velocity, ejection amount, and so on) change depending on the temperature, viscosity, and so on of the ink within the pressure chamber, it is preferable for such a liquid ejection technique to employ a configuration that controls the ejection based on the temperature, viscosity, and so on of the ink. For example, JP-A-2006-35812 employs a technique that detects the viscosity of ink by measuring the resonance frequency or antiresonance frequency of a piezoelectric element and determines a driving voltage for the piezoelectric element based on the viscosity of the ink.

Incidentally, while the viscosity of the ink within the pressure chamber changes depending on the temperature thereof, the viscosity of the ink also increases due to solvent evaporating from the liquid surface (meniscus) exposed in the nozzle. It is possible that such a thickening of the ink due to evaporation of the solvent will not be completely rectified within the period in which printing operations are carried out. Extensive thickened components remain particularly in ink corresponding to nozzles that have long idle periods (periods in which ink is not ejected). Accordingly, using the technique in JP-A-2006-35812 that detects the viscosity of ink during periods in which printing is carried out, it is difficult to accurately detect the viscosity of ink components that have not thickened within the pressure chamber (that is, a viscosity resulting from a cause aside from the stated thickening).

### SUMMARY

A liquid ejecting apparatus according to an aspect of the invention includes: a liquid ejecting head, having a pressure chamber filled with a liquid and a pressure generation element that causes the pressure of the liquid within the pressure chamber to fluctuate, that is capable of executing ejection driving that ejects the liquid from the nozzle based on the pressure fluctuation in the liquid within the pressure chamber; a driving waveform generation unit that generates a driving waveform for executing the ejection driving; a control unit that causes the liquid ejecting head to execute a flushing operation that discharges the liquid within the pressure chamber; and a residual vibration detection unit that detects a residual vibration in the liquid within the pressure chamber. The control unit corrects the driving waveform based on the residual vibration produced by the flushing operation. According to this configuration, residual vibrations in the liquid produced by the flushing operation are detected, and thus influence of thickened components within the pressure chamber on the residual vibrations can be reduced; this makes it possible to more suitably correct the driving waveform.

According to another aspect of the invention, it is preferable that the control unit calculate a characteristic value indicating a characteristic of the liquid based on the residual vibration produced by the flushing operation, and correct the driving waveform based on the characteristic value. According to this configuration, the driving waveform is corrected based on the characteristic value calculated based on the residual vibration, and thus the correction of the driving waveform is more suitable.

According to another aspect of the invention, it is preferable that the control unit calculate a first characteristic value based on the residual vibration produced by a first flushing operation, cause the execution of a second flushing operation that ejects the liquid of an amount based on the first characteristic value, calculate a second characteristic value based on the residual vibration produced by the second flushing operation, and correct the driving waveform based on the second characteristic value. In the aforementioned configuration, the amount of liquid ejected in the second flushing operation (that is, the amount of liquid based on the first characteristic value) includes an ejection amount of zero, or in other words, involving a concept that includes not ejecting the liquid in the second flushing operation.

With a configuration in which the amount of liquid that is ejected is constant in the flushing operation regardless of the characteristic value of the liquid, there is a chance that the thickened components of the liquid will not be sufficiently discharged, or a chance that an excessive amount of liquid will be discharged. According to the aforementioned configuration, the first characteristic value is calculated based on the residual vibrations produced by the first flushing operation, and the second flushing operation that ejects an amount of liquid based on the first characteristic value is then executed. The thickened components in the pressure chamber are thus sufficiently discharged even in the case where the viscosity of the liquid has increased. Accordingly, the characteristic value of the liquid that reduces the influence of the thickening can be calculated, and thus the driving waveform can be corrected in a more appropriate manner. Meanwhile, an excessive amount of liquid is suppressed from being ejected in the second flushing operation in the case where the viscosity of the liquid has decreased, which further reduces the amount of liquid that is consumed.

According to another aspect of the invention, it is preferable that the control unit: cause the flushing operation to be executed every adjustment period, the adjustment period being a different period from a period in which the liquid ejecting head ejects the liquid onto a recording medium; and determine the amount of liquid to be ejected in the second flushing operation of the current adjustment period in accordance with a result of comparing the first characteristic value or the second characteristic value of a previous adjustment period with the first characteristic value of the current adjustment period.

With a configuration that determines the amount of liquid to be ejected in the second flushing operation based only on the characteristic value in the current adjustment period, there is a chance, in the case where the liquid within the pressure chamber has suddenly thickened between a past adjustment period and the current adjustment period, that the thickened components of the liquid cannot be sufficiently discharged through the second flushing operation in the current adjustment period. According to the aforementioned configuration, the amount of liquid to be ejected in the second flushing operation of the current adjustment period is determined in accordance with a result of comparing a characteristic value (the first characteristic value or the second characteristic value) of a past adjustment period with the first characteristic value of the current adjustment period. It is thus easier to discharge a sufficient amount of thickened components from within the pressure chamber, even in the case where the liquid within the pressure chamber has suddenly thickened. Accordingly, the characteristic value of the liquid that reduces the influence of the thickening can be calculated, and thus the driving waveform can be corrected in a more appropriate manner.

According to another aspect of the invention, it is preferable that the control unit specify a temperature of the liquid based on the characteristic value and correct the driving waveform based on the temperature. According to this configuration, it is possible to correct the driving waveform based on the characteristic value using a configuration in which the driving waveform is corrected based on the temperature of the liquid.

According to another aspect of the invention, it is preferable that the liquid ejecting apparatus further include a heating device that heats the ejected liquid. According to this configuration, the characteristics of the liquid change more easily due to the heating performed by the heating device, and thus the effects achieved by the aforementioned configurations are even more prominent.

The invention can also be implemented as a control method for a liquid ejecting apparatus according to the aforementioned aspects. The control method for a liquid ejecting apparatus according to an aspect of the invention is a control method for a liquid ejecting apparatus that includes: a liquid ejecting head, having a pressure chamber filled with a liquid and a pressure generation element that causes the pressure of the liquid within the pressure chamber to fluctuate, that is capable of executing ejection driving that ejects the liquid from the nozzle based on the pressure fluctuation in the liquid within the pressure chamber; a driving waveform generation unit that generates a driving waveform for executing the ejection driving; a control unit that causes the liquid ejecting head to execute a flushing operation that discharges the liquid within the pressure chamber; and a residual vibration detection unit that detects a residual vibration in the liquid within the pressure chamber. The method includes correcting the driving waveform based on the residual vibration produced by the flushing operation. The same actions and effects as the liquid ejecting apparatus according to the invention are achieved by the aforementioned control method as well.

### BRIEF DESCRIPTION OF THE DRAWINGS

The invention will be described with reference to the accompanying drawings, wherein like numbers reference like elements.

FIG. 1 is a partial schematic diagram illustrating a printing apparatus according to a first embodiment of the invention.

FIG. 2 is a plan view of an ejection surface of a recording head.

FIGS. 3A, 3B, and 3C are diagrams illustrating the configuration of a recording head.

FIG. 4 is a descriptive diagram illustrating printing periods and adjustment periods.

FIG. 5 is a block diagram illustrating the electrical configuration of a printing apparatus.

FIG. 6 is a waveform diagram illustrating a driving signal.

FIG. 7 is a block diagram illustrating the electrical configuration of a recording head.

FIG. 8 is a descriptive diagram illustrating residual vibrations in a vibrating plate arising due to ejection driving.

FIG. 9 is a configuration diagram illustrating an element control circuit.

FIG. 10 is a configuration diagram illustrating an element control circuit.

FIG. 11 is a diagram illustrating tables used to correct driving signals.

FIG. 12 is a flowchart illustrating operations performed in the first embodiment.

FIG. 13 is a diagram illustrating a specific example of the correction of a driving signal.

FIG. 14 is a flowchart illustrating operations performed in a second embodiment.

FIG. 15 is a diagram illustrating a table that associates characteristic values with instances of ejection driving.

FIG. 16 is a flowchart illustrating operations performed in a third embodiment.

FIG. 17 is a partial schematic diagram illustrating a printing apparatus according to a variation.

FIG. 18 is a waveform diagram illustrating a driving signal according to a variation.

FIGS. 19A and 19B are diagrams illustrating waveforms generated from a driving signal according to a variation.

FIG. 20 is a diagram illustrating closed regions formed by a detection waveform signal and a reference potential.

### DESCRIPTION OF EXEMPLARY EMBODIMENTS

### First Embodiment

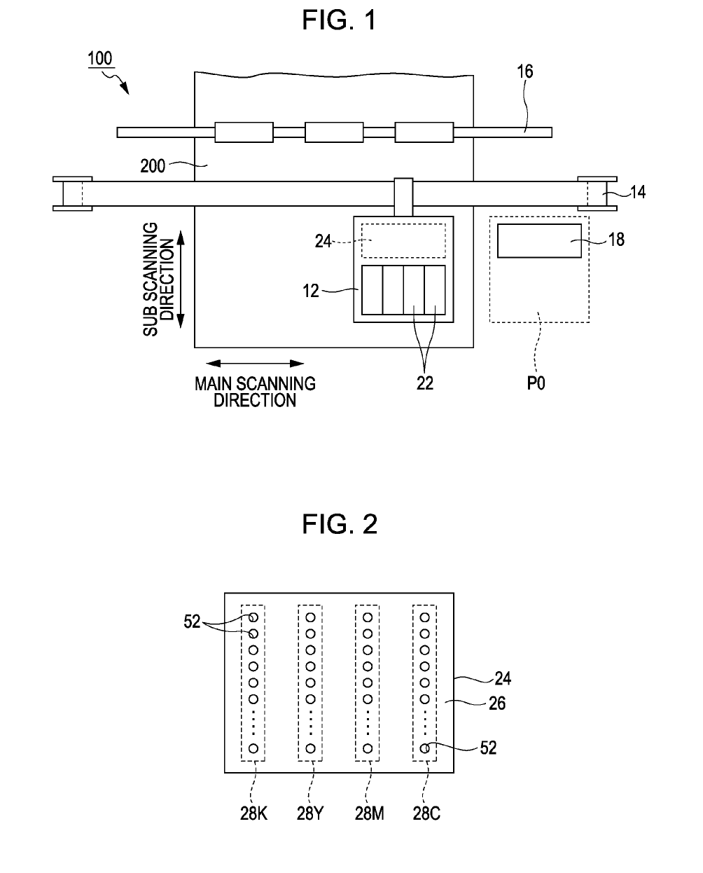

FIG. 1 is a partial schematic diagram illustrating an ink jet printing apparatus 100 according to a first embodiment of the invention. The printing apparatus 100 is a liquid ejecting apparatus that ejects ink droplets onto recording paper 200, and includes a carriage 12, a movement mechanism 14, and a paper transport mechanism 16.

Ink cartridges 22 and a recording head 24 are mounted in the carriage 12. The ink cartridges 22 are receptacles that hold ink (liquid) to be ejected onto the recording paper 200. The recording head 24 functions as a liquid ejecting head that ejects the ink held in the ink cartridges 22 onto the recording paper 200. Note that a configuration in which the ink cartridges 22 are fixed to a housing (not shown) of the printing apparatus 100 and the ink is supplied to the recording head 24 therefrom can also be employed.

FIG. 2 is a plan view of an ejection surface 26 of the recording head 24 that faces the recording paper 200. As shown in FIG. 2, a plurality of nozzle rows 28 (28K, 28Y, 28M, and 28C) that correspond to different colors of ink (black (K), yellow (Y), magenta (M), cyan (C)) are formed in the ejection surface 26 of the recording head 24. Each nozzle row 28 is a collection of N nozzles (ejection openings) 52 (where N is a natural number) arranged in a straight line in a sub scanning direction. Each nozzle 52 in the nozzle row 28K ejects black (K) ink. Likewise, each nozzle 52 in the nozzle row 28Y ejects yellow (Y) ink, each nozzle 52 in the nozzle row 28M ejects magenta (M) ink, and each nozzle 52 in the nozzle row 28C ejects cyan (C) ink. Note that a configuration in which the nozzles 52 are arranged in a staggered manner may also be employed.

The movement mechanism 14 shown in FIG. 1 moves the carriage 12 back and forth in a main scanning direction (the width direction of the recording paper 200). The position of the carriage 12 is detected by a detector such as a linear encoder (not shown), and is used in the control performed by the movement mechanism 14. The paper transport mechanism 16 moves the recording paper 200 in the sub scanning direction as the carriage 12 moves back and forth. A desired image is recorded (printed) onto the recording paper 200 by the recording head 24 ejecting the ink onto the recording paper 200 while the carriage 12 moves back and forth.

The movement mechanism 14 can move the recording head 24 to a position P0 outside of the range in which the ejection surface 26 opposes the recording paper 200 (this will be called a “withdrawn position” hereinafter). A cap 18 is disposed so as to oppose the ejection surface 26 of the recording head 24 when the recording head 24 is at the withdrawn position P0. The cap 18 seals the ejection surface 26 of the recording head 24. A wiper (not shown) that wipes the ejection surface 26 is disposed in the vicinity of the cap 18. At the withdrawn position P0, the recording head 24 carries out flushing operations for discharging ink that has thickened or the like and is thus no longer suitable for ejection. Executing such flushing operations eliminates clogs from the nozzles 52, bubbles that have entered into pressure chambers 50, and so on.

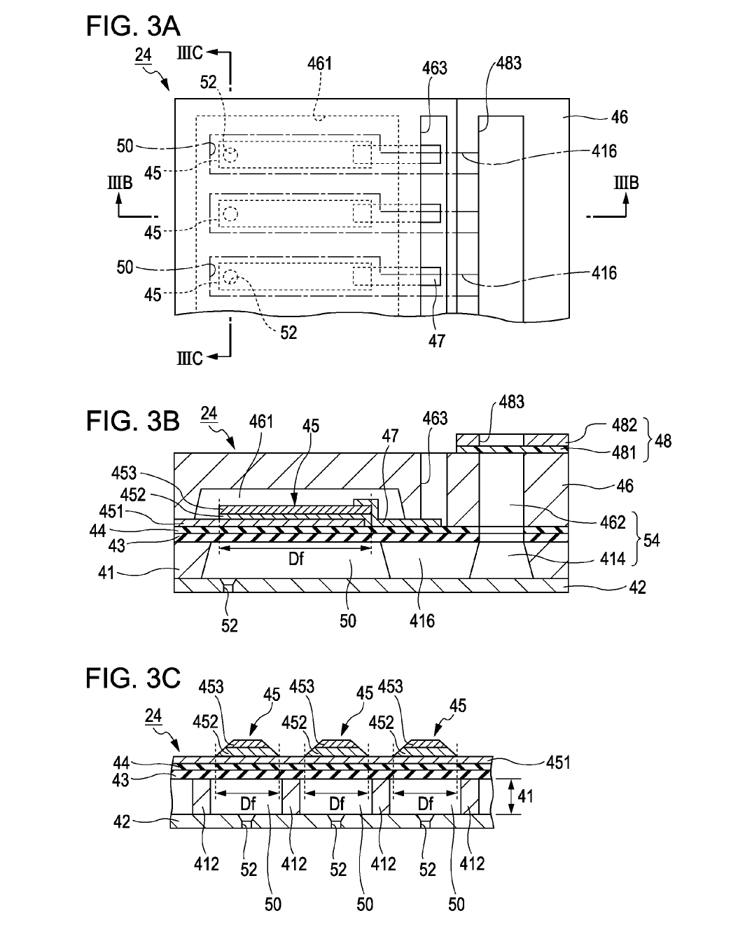

FIGS. 3A, 3B, and 3C are diagrams illustrating the configuration of the recording head 24 according to the first embodiment. Specifically, FIG. 3A is a plan view of the recording head 24, FIG. 3B is a cross-sectional view taken along the IIIB-IIIB line shown in FIG. 3A, and FIG. 3C is a cross-sectional view taken along the IIIC-IIIC line shown in FIG. 3A. As shown in FIGS. 3A through 3C, the recording head 24 has an overall structure in which a flow channel formation plate 41, a nozzle formation plate 42, an elastic film 43, an insulation film 44, piezoelectric elements 45, and a protective plate 46 are layered upon each other.

The flow channel formation plate 41 is a plate-shaped member configured of, for example, a metal plate such as stainless steel or a silicon single-crystal substrate. As shown in FIG. 3A and FIG. 3C, a plurality of long pressure chambers 50 are arranged in the flow channel formation plate 41 along the width direction (that is, the direction in which the nozzles 52 are arranged). Adjacent pressure chambers 50 are separated by partition walls 412. Furthermore, a communication portion 414 is formed in a region of the flow channel formation plate 41 that is on the outer side in the lengthwise direction of the pressure chambers 50. The communication portion 414 and the pressure chambers 50 communicate with each other via ink supply channels 416 that are formed for each of the pressure chambers 50. The ink supply channels 416 are formed so as to be narrower than the pressure chambers 50, and thus impart a constant flow channel resistance on the ink that flows into the pressure chambers 50 from the communication portion 414.

As shown in FIG. 3B and FIG. 3C, the nozzle formation plate 42 is affixed to a surface (an open surface) of the flow channel formation plate 41 with, for example, an adhesive, a thermally-welded film, or the like. The nozzles (through-holes) 52 are formed in the nozzle formation plate 42, in the ends of the pressure chambers 50 that are on the opposite side as the ink supply channels 416. Meanwhile, the elastic film 43 is formed on the surface of the flow channel formation plate 41 that is on the opposite side as the nozzle formation plate 42, and is formed of, for example, silicon dioxide (SiO₂). The insulation film 44 is formed on the surface of the elastic film 43 using, for example, zirconium oxide (ZrO₂), and the piezoelectric elements 45 are formed for each of the pressure chambers 50 on the surface of the insulation film 44. The portions of the elastic film 43 and insulation film 44 that oppose the piezoelectric elements 45 (piezoelectric materials 452) (that is, the portions indicated by the double-sided arrows in FIGS. 3B and 3C) are vibrating plates Df. In other words, the vibrating plates Df are provided for each of the piezoelectric elements 45 (each of the pressure chambers 50).

As shown in FIGS. 3B and 3C, each of the piezoelectric elements 45 has a structure in which a lower electrode 451, a piezoelectric material 452, and an upper electrode 453 are stacked in that order from the side on which the insulation film 44 is located. One of the lower electrode 451 and the upper electrode 453 serves as a common electrode that is continuous across the plurality of pressure chambers 50, whereas the other of the lower electrode 451 and the upper electrode 453, as well as the piezoelectric material 452, is formed (patterned) individually for each of the pressure chambers 50. Which of the lower electrode 451 and the upper electrode 453 to use as the common electrode is determined as appropriate based on, for example, the polarity direction of the piezoelectric material 452, wiring conditions, and so on. Lead electrodes 47, formed of gold (Au) or the like, are connected to the upper electrodes 453 of the piezoelectric elements 45. The piezoelectric elements 45 and the corresponding vibrating plates Df deform (bend) when driving signals are supplied via the lead electrodes 47 and an electrical field is generated between the lower electrode 451 and the upper electrodes 453. Note that in addition to the aforementioned configuration, a vibrating member such as an electrostatic actuator or the like may be used as the piezoelectric element 45 instead.

As shown in FIG. 3B, the protective plate 46 is affixed to the surface of the flow channel formation plate 41 on which the piezoelectric elements 45 are provided. Piezoelectric element holding portions 461 that hold the piezoelectric elements 45 are formed in the regions of the protective plate 46 that oppose the piezoelectric elements 45. The piezoelectric element holding portions 461 are formed having a size that does not interfere with the displacement of the piezoelectric elements 45, and protect each of the piezoelectric elements 45. Meanwhile, a reservoir portion 462 that passes through the protective plate 46 is formed in the protective plate 46 in a region that corresponds to the communication portion 414 of the flow channel formation plate 41. The reservoir portion 462 is a long space that follows the direction in which the pressure chambers 50 are arranged. The space formed by the communication portion 414 of the flow channel formation plate 41 and the reservoir portion 462 of the protective plate 46 communicating with each other configures a reservoir 54 that functions as a common ink chamber for the pressure chambers 50.

A through-hole 463 that passes through the protective plate 46 in the thickness direction thereof is formed in the region of the protective plate 46 that is between the piezoelectric element holding portions 461 and the reservoir portion 462. The lower electrode 451 and the lead electrodes 47 of the piezoelectric elements 45 are exposed on the inside of the through-hole 463. Meanwhile, a compliance plate 48, in which a sealing film 481 and an anchor plate 482 are stacked, is affixed to the top surface of the protective plate 46. The sealing film 481 is configured of a low-rigidity, flexible material (for example, a polyphenylene sulfide film), and seals the reservoir portion 462 of the protective plate 46. The anchor plate 482, meanwhile, is configured of a hard material such as a metal (for example, stainless steel). An opening portion 483 is formed in the region of the anchor plate 482 that opposes the reservoir 54 (the reservoir portion 462).

In the recording head 24 configured as described thus far, ink supplied from the ink cartridges 22 fills the space spanning from the reservoir 54 to the nozzles 52 via the ink supply channels 416 and the pressure chambers 50. The pressure within the pressure chambers 50 fluctuates when the piezoelectric elements 45 and the vibrating plates Df deform as driving signals are supplied thereto. By controlling the pressure fluctuations within the pressure chambers 50 based on the driving signals, operations for ejecting the ink within the pressure chambers 50 from the nozzles 52 (called “ejection driving” hereinafter) or operations for causing minute vibrations in the liquid surface (meniscus) of the ink within the nozzles 52 without ejecting ink from the pressure chambers 50 (called “minute vibration driving” hereinafter) can be executed.

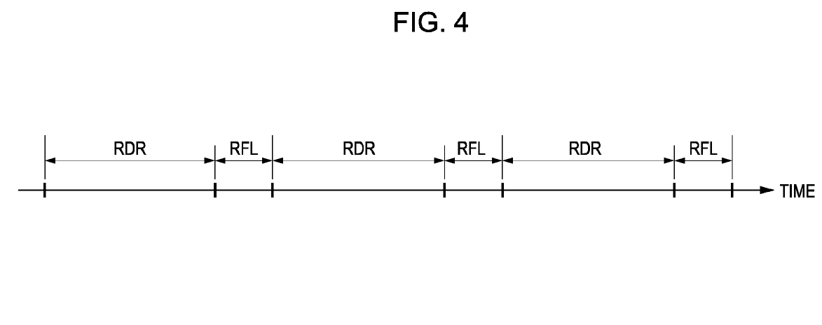

As shown in FIG. 4, the operating period of the printing apparatus 100 is divided into a printing period RDR and an adjustment period RFL. The printing period RDR is a period in which an image is formed on the recording paper 200 by ejecting ink through ejection driving. The printing period RDR is a period in which, for example, the carriage 12 makes one back-and-forth pass in the main scanning direction starting from the withdrawn position P0 as ink is ejected from the recording head 24. On the other hand, the adjustment period RFL is a period, located between previous and following printing periods RDR, in which the recording head 24 is moved to the withdrawn position P0 and adjustment operations are executed in preparation for the forming of images (the ejection of ink) in the printing period RDR. In the adjustment period RFL, flushing operations, in which ink is forcefully ejected from nozzles 52 (in other words, with no relation to print data DP), are executed. As a result of flushing operations, thickened components of the ink within the pressure chambers 50 are discharged and thickening of the ink is eliminated. In the flushing operations, N (where N is a natural number; for example, N=100) ejection drivings are executed.

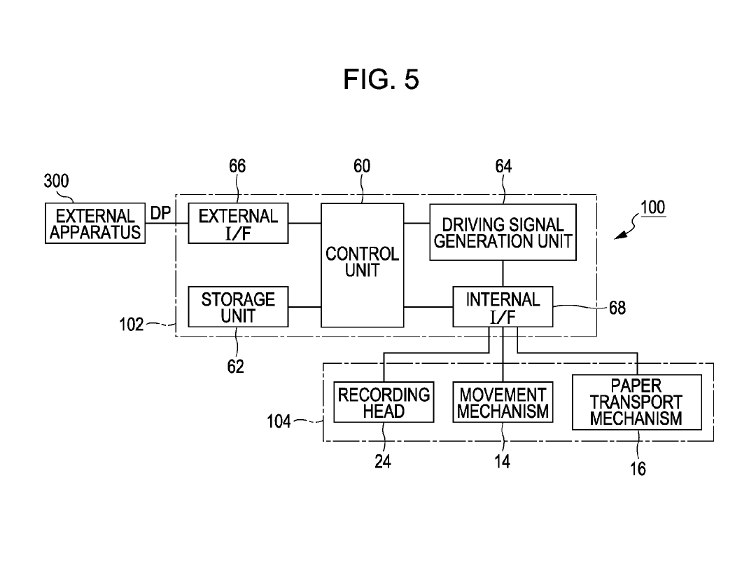

FIG. 5 is a block diagram illustrating the electrical configuration of the printing apparatus 100. As shown in FIG. 5, the printing apparatus 100 includes a controlling unit 102 and a print processing unit (print engine) 104. The controlling unit 102 is an element that controls the printing apparatus 100 as a whole, and includes a control unit 60, a storage unit 62, a driving signal generation unit 64, an external I/F (interface) 66, and an internal I/F 68. The print data DP, which expresses an image to be printed on the recording paper 200, is supplied to the external I/F 66 from an external apparatus (for example, a host computer) 300, and the print processing unit 104 is connected to the internal I/F 68. The print processing unit 104 is an element that records images onto the recording paper 200 based on the control performed by the controlling unit 102, and includes the aforementioned recording head 24, the movement mechanism 14, and the paper transport mechanism 16.

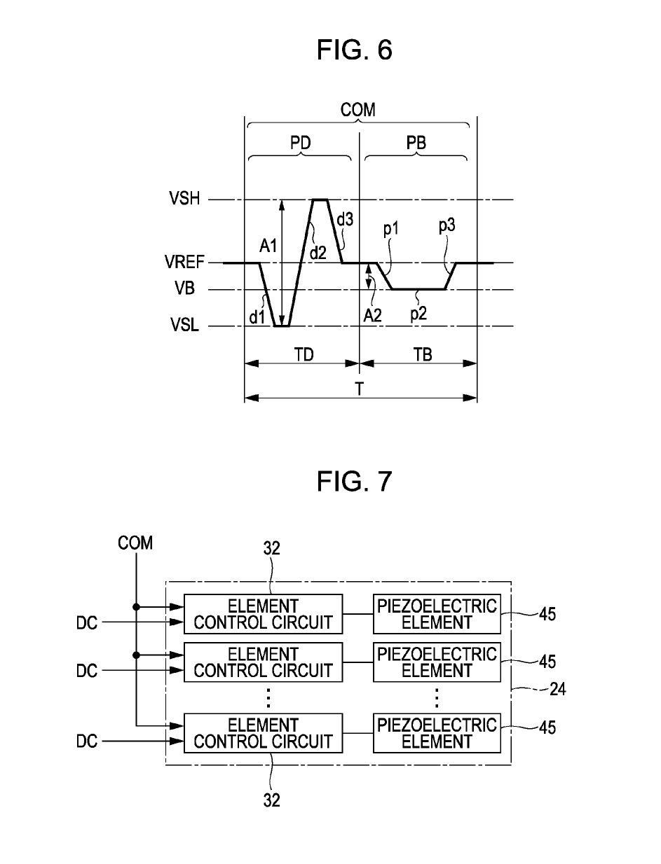

The driving signal generation unit 64 generates a driving signal COM in the printing period RDR and the adjustment period RFL. The driving signal COM is a periodic signal that drives the piezoelectric elements 45. As shown in FIG. 6, an ejection pulse PD and a minute vibration pulse PB are provided within a period T (called a “print cycle” hereinafter) that corresponds to one cycle of the driving signal COM. The ejection pulse PD is a waveform that includes a segment d1 in which the potential changes from a predetermined reference potential VREF to a potential VSL that is lower than the reference potential VREF (that is, the direction that depressurizes the pressure chambers 50), a segment d2 in which the potential changes to a potential VSH that is higher than the reference potential VREF (that is, the direction that pressurizes the pressure chambers 50), and a segment d3 in which the potential returns to the reference potential VREF; when supplied to the piezoelectric elements 45, the ejection pulse PD causes the piezoelectric elements 45 and the vibrating plates Df to deform and pressurizes the ink within the pressure chambers 50 in order to eject a predetermined amount of ink from the nozzles 52. Meanwhile, the minute vibration pulse PB is a trapezoidal-shaped waveform that includes a segment p1 in which the potential changes from the predetermined reference potential VREF to a lower potential VB, a segment p2 in which the potential VB of the lower end of the segment p1 is held, and a segment p3 in which the potential rises to return to the reference potential VREF; when supplied to the piezoelectric elements 45, the minute vibration pulse PB causes the pressure within the pressure chambers 50 to change by a degree that does not eject the ink within the pressure chambers 50 from the nozzles 52, and causes minute vibrations (fluctuations) in the meniscuses of the nozzles 52. A potential fluctuation range A1 of the ejection pulse PD (where A1=VSH−VSL) and a potential fluctuation range A2 of the minute vibration pulse PB (where A2=VREF−VB) can be changed through corrections made by the control unit 60.

The storage unit 62 shown in FIG. 5 includes a ROM that stores control programs and the like and a RAM that temporarily stores various types of data required for the printing of images and so on. The control unit 60 collectively controls the various constituent elements of the printing apparatus 100 (such as the print processing unit 104) by executing control programs stored in the storage unit 62. Specifically, the control unit 60 generates control data DC that specifies operations of the piezoelectric elements 45 within each print cycle T. The control data DC is data specifying, as operations of the piezoelectric elements 45, the ejection driving for ejecting the ink within the pressure chambers 50 from the nozzles 52, or the minute vibration driving for instigating minute vibrations in the meniscuses of the ink within the nozzles 52. The control data DC is repeatedly generated every print cycle T. In the printing period RDR, the control data DC specifying ejection driving or minute vibration driving is generated in accordance with the print data DP. On the other hand, in the adjustment period RFL, the control data DC specifying N instances of ejection driving as flushing operations is generated, regardless of the print data DP.

FIG. 7 is a schematic diagram illustrating the electrical configuration of the recording head 24. As shown in FIG. 7, the recording head 24 includes a plurality of element control circuits 32 each of which corresponds to a different piezoelectric element 45. Each of the element control circuits 32 includes a driving circuit 322, a residual vibration detection circuit 324, and a switching circuit 326. The driving signal COM generated by the driving signal generation unit 64 is supplied in common to the plurality of driving circuits 322 via the internal I/F 68. Meanwhile, the control data DC generated by the control unit 60 is supplied to the driving circuits 322 via the internal I/F 68.

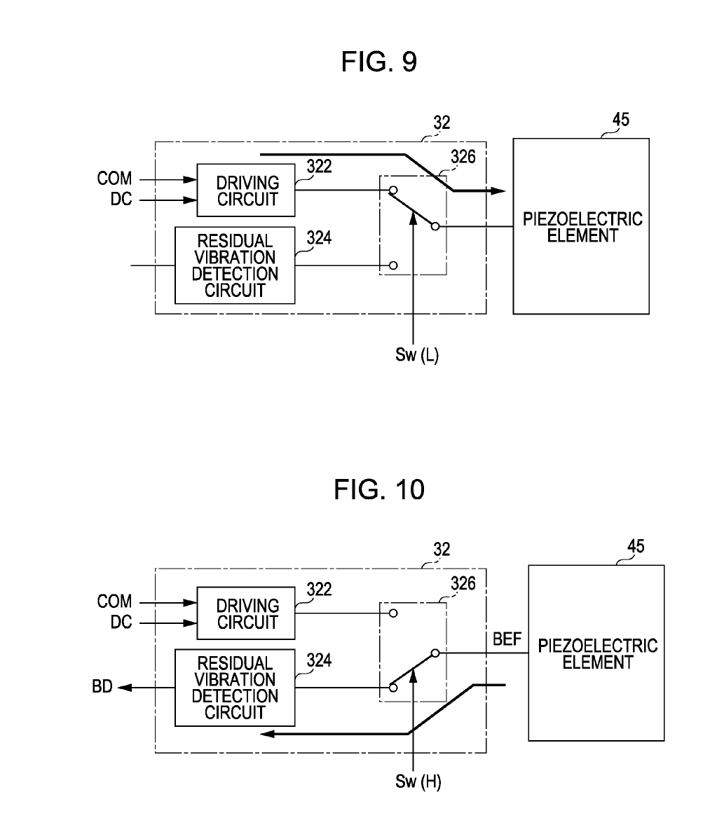

The switching circuit 326 is a switch that connects the driving circuit 322 or residual vibration detection circuit 324 to the piezoelectric element 45 in accordance with a selection signal Sw supplied from the control unit 60. When the selection signal Sw is at low level, the switching circuit 326 connects the piezoelectric element 45 to the driving circuit 322, as shown in FIG. 9. The driving circuit 322 selects a segment from the driving signal COM based on the control data DC supplied from the control unit 60 and supplies that segment to the piezoelectric element 45. Specifically, in the case where the control data DC specifies ejection driving, the driving circuit 322 selects the ejection pulse PD of the driving signal COM and supplies that ejection pulse PD to the piezoelectric element 45. Accordingly, the ink within the pressure chamber 50 is ejected from the nozzle 52 (ejection driving). Meanwhile, in the case where the control data DC specifies minute vibration driving, the driving circuit 322 selects the minute vibration pulse PB of the driving signal COM and supplies the minute vibration pulse PB to the piezoelectric element 45. Accordingly, minute vibrations are instigated in the meniscus within the nozzle 52 and the ink within the pressure chamber 50 is agitated to an appropriate degree without being ejected (minute vibration driving). In the printing period RDR, the selection signal Sw is held at low level, and thus the switching circuit 326 always connects the piezoelectric element 45 to the driving circuit 322.

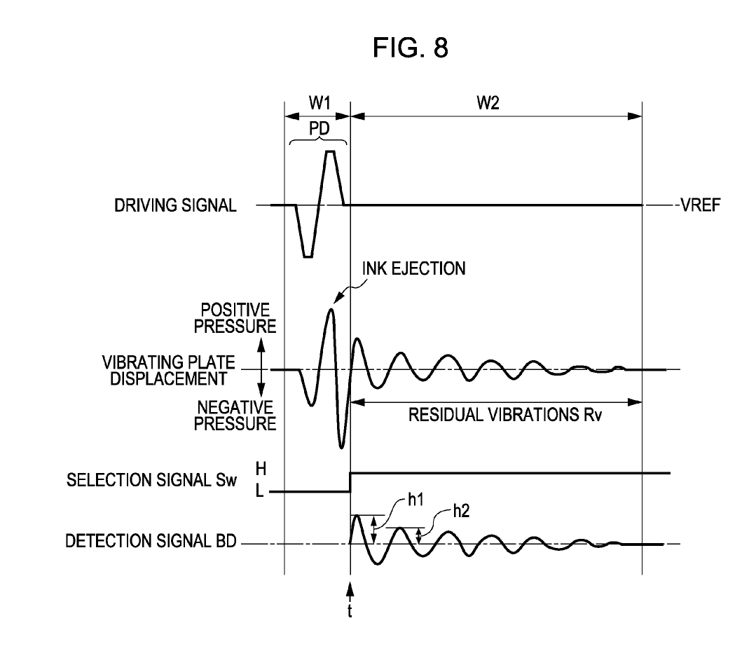

FIG. 8 is a diagram illustrating displacement in the vibrating plate Df after the ejection of ink. When the ejection pulse PD is supplied to the piezoelectric element 45 in a period W1, the vibrating plate Df displaces, and the ink within the pressure chamber 50 is pressurized and ejected as a result. After the ejection pulse PD has been supplied, the displacement (vibrations) in the vibrating plate Df and the ink within the pressure chamber 50 does not stop immediately, and remains as residual vibrations Rv. The vibrations in the vibrating plate Df and the ink within the pressure chamber 50 are affected by the characteristics of the ink within the pressure chamber 50 (such as the viscosity of the ink). For example, the higher is the viscosity of the ink, the higher is the degree to which a wave height h of the residual vibrations Rv will drop.

On the other hand, when the selection signal Sw is at high level, the switching circuit 326 connects the piezoelectric element 45 to the residual vibration detection circuit 324, as shown in FIG. 10. When the vibrating plate Df vibrates, a back electromotive force BEF is generated in the piezoelectric element 45. The residual vibration detection circuit 324 detects and outputs a detection signal BD that is based on the back electromotive force BEF supplied from the piezoelectric element 45 via the switching circuit 326. The residual vibration detection circuit 324 is, for example, a filter that allows only the frequency band of the back electromotive force BEF that corresponds to the residual vibrations Rv to pass, an amplifier that amplifies the back electromotive force BEF, or a combination of these. Note that a configuration in which the switching circuit 326 is not provided and the driving circuit 322 and residual vibration detection circuit 324 are individually connected to the piezoelectric element 45 may be employed as well.

The detection signal BD, generated by the residual vibration detection circuit 324 in accordance with the back electromotive force BEF, is supplied to the control unit 60. The control unit 60 calculates a characteristic value Cv based on the detection signal BD. As described earlier, the vibration of the vibrating plate Df is affected by the characteristics of the ink, and thus the characteristics of the ink are also reflected in the back electromotive force BEF. Accordingly, the characteristic value Cv is a numerical value based on the characteristics of the ink (for example, the viscosity). Specifically, the ratio of the wave heights of two adjacent peaks in the detection signal BD (the residual vibrations Rv) (for example, the ratio of a wave height h2 to a wave height h1 shown in FIG. 8 (Cv=h2/h1)) is calculated as the characteristic value Cv. The higher is the viscosity of the ink, the higher is the degree to which a wave height h will drop, and thus the characteristic value Cv will decrease.

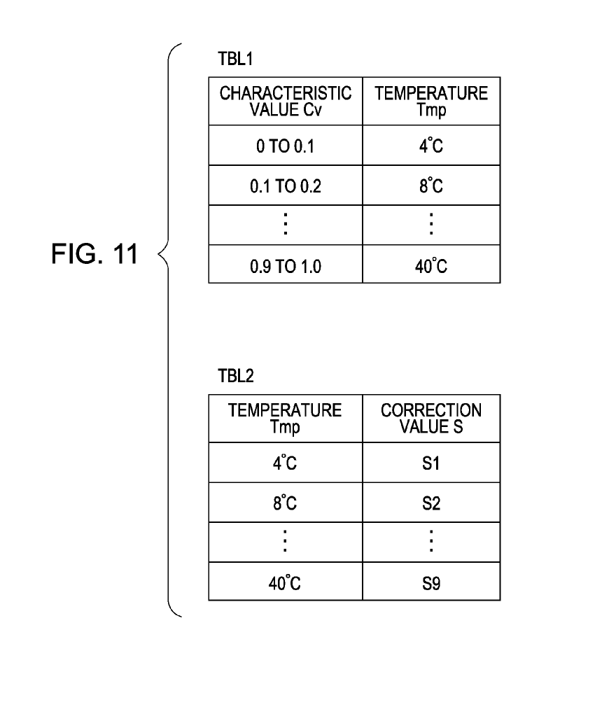

The control unit 60 corrects the driving signal COM based on the characteristic value Cv. Specifically, the control unit 60 issues an instruction to the driving signal generation unit 64 specifying a correction value S based on the characteristic value Cv. A table TBL1 and a table TBL2, shown as examples in FIG. 11, are used in specifying the correction value S. As shown in FIG. 11, in the table TBL1, respective numerical values for the characteristic value Cv and temperature Tmp are associated with each other. The correlations between the characteristic value Cv and the temperature Tmp indicated in the table TBL1 are set in advance, experimentally or statistically. Meanwhile, respective numerical values for the temperature Tmp and the correction value S are associated with each other in the table TBL2. The correction value S is a value specifying parameters of the driving signal COM (for example, the potential fluctuation range A1 of the ejection pulse PD, the potential fluctuation range A2 of the minute vibration pulse PB, and so on), and is set in advance, experimentally or statistically, so that the ink ejection characteristics are close to the same at each temperature Tmp. The control unit 60 specifies the temperature Tmp of the ink based on the characteristic value Cv by referring to the table TBL1, finds the correction value S corresponding to that temperature Tmp from the table TBL2, and issues that correction value S to the driving signal generation unit 64. The driving signal generation unit 64 generates the driving signal COM based on the correction value S instructed by the control unit 60. In this manner, the characteristic value Cv is calculated based on the residual vibrations Rv produced by the flushing operations, and the driving signal COM is corrected based on the characteristic value Cv.

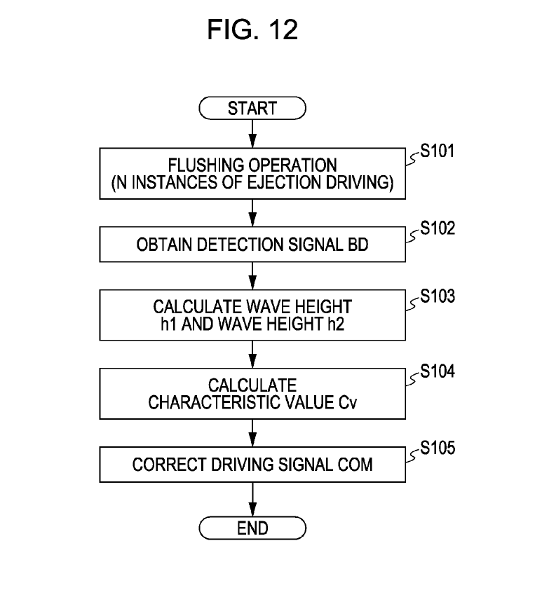

FIG. 12 is an example of a flow of operations through which the control unit 60 corrects the driving signal COM in the adjustment period RFL. When the printing period RDR ends and the adjustment period RFL begins, the control unit 60 sets the selection signal Sw supplied to the switching circuit 326 to low level and connects the piezoelectric element 45 to the driving circuit 322, and furthermore supplies the control data DC to the driving circuit 322 and instructs N instances of ejection driving (flushing operations) to be executed (step S101). As shown in FIG. 8, the control unit 60 sets the selection signal Sw to high level at a time t, after a predetermined amount of time has passed following the instruction of the Nth instance of ejection driving, and connects the piezoelectric element 45 to the residual vibration detection circuit 324. The time t is a point in time immediately after the ejection pulse PD corresponding to the Nth instance of ejection driving has been supplied to the piezoelectric element 45, and is a point in time in which vibrations in the vibrating plate Df produced by the ejection driving remain as residual vibrations Rv. Accordingly, a detection signal BD based on the residual vibrations Rv (that is, the back electromotive force BEF) produced by the Nth instance of ejection driving is generated by the residual vibration detection circuit 324. The control unit 60 obtains the detection signal BD generated by the residual vibration detection circuit 324 (step S102), and calculates the wave height h1 and wave height h2 of the detection signal BD (step S103). The control unit 60 then calculates the characteristic value Cv (h2/h1) from the calculated wave height h1 and wave height h2 (step S104). The control unit 60 then specifies the correction value S corresponding to the calculated characteristic value Cv using the table TBL1 and the table TBL2, and issues the specified correction value S to the driving signal generation unit 64 (step S105). After the flow of operations shown in FIG. 12 ends, the next printing period RDR begins.

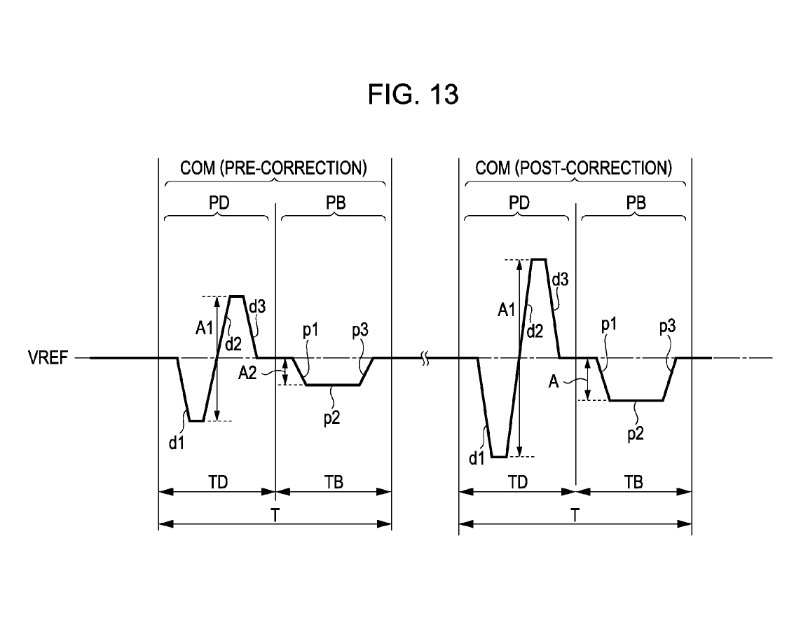

FIG. 13 is a diagram illustrating a specific example of the correction of the driving signal COM. The pre-correction driving signal COM corresponds to a correction value S2 (temperature Tmp=8° C.) in the table TBL2 (FIG. 11), whereas the post-correction driving signal COM corresponds to a correction value S1 (temperature Tmp=4° C.) in the table TBL2. In other words, FIG. 13 illustrates an example of the correction of the driving signal COM in the case where the temperature Tmp of the ink specified by the characteristic value Cv has dropped. Compared to the pre-correction potential fluctuation range A1, in the post-correction ejection pulse PD, the potential fluctuation range A1 is greater, and the slope of the sloped waveforms (a waveform d1, a waveform d2, and a waveform d3) has also increased. In other words, the post-correction ejection pulse PD is suited to the ejection of ink at lower temperatures (higher viscosities) than the pre-correction ejection pulse PD. Furthermore, compared to the pre-correction minute vibration pulse PB, in the post-correction minute vibration pulse PB, the potential fluctuation range A2 is greater, and the slope of the sloped waveforms (a waveform p1 and a waveform p3) has also increased. In other words, the post-correction minute vibration pulse PB is suited to the minute vibrations of ink at lower temperatures (higher viscosities) than the pre-correction minute vibration pulse PB.

According to the first embodiment described thus far, the residual vibrations Rv of the vibrating plates Df produced by the flushing operations in the adjustment period RFL are detected, and thus the influence of thickened components in the pressure chambers 50 on the residual vibrations Rv can be reduced, as compared to a configuration in which the residual vibrations Rv are detected in the printing period RDR. Accordingly, the characteristic value Cv of the ink that reduces the influence of the thickening of the ink can be calculated, and thus the driving signal COM can be corrected in a more appropriate manner.

### Second Embodiment

A second embodiment of the invention will be described next. Note that for elements in the following embodiments that have the same effects, functions, and so on as those in the first embodiment, the reference numerals referred to in the above descriptions will be applied, and detailed descriptions thereof will be omitted as appropriate.

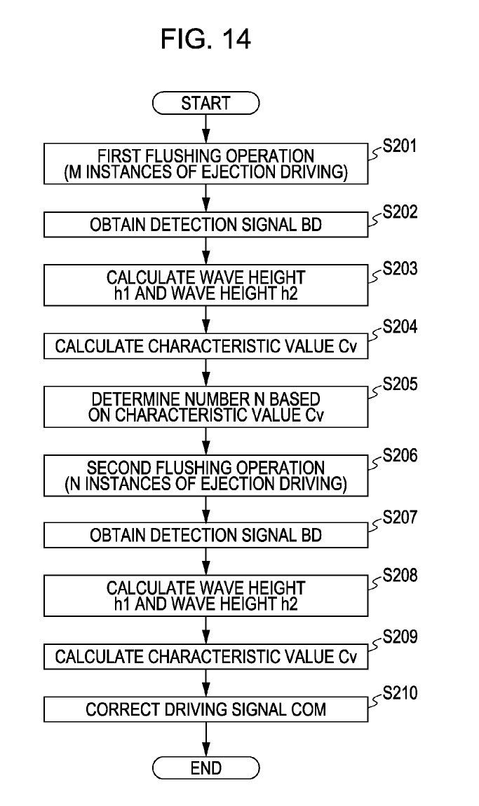

FIG. 14 is an example of a flow of operations through which the control unit 60 according to the second embodiment corrects the driving signal COM in the adjustment period RFL. In the second embodiment, a first flushing operation (step S201) and a second flushing operation (step S206) are executed. An amount of ink based on the result of the first flushing operation is ejected in the second flushing operation.

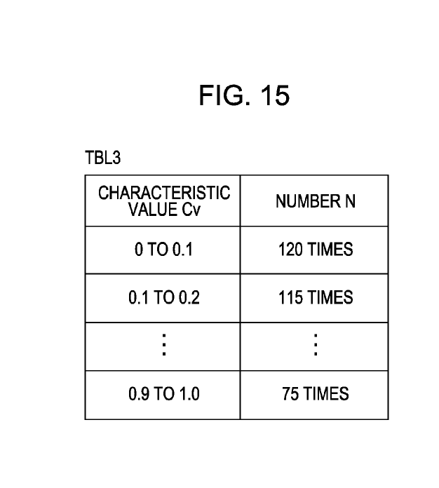

When the printing period RDR ends and the adjustment period RFL begins, the control unit 60 connects the piezoelectric element 45 to the driving circuit 322 by controlling the switching circuit 326, and furthermore supplies the control data DC to the driving circuit 322 and instructs M instances (where M is a natural number) of ejection driving (the first flushing operation) to be executed (step S201). The number M is a number that is lower than the number of ejection drivings N carried out in the second flushing operation, and is, for example, 10. As in the first embodiment, after the final (Mth) instance of ejection driving in the first flushing operation has been instructed, the piezoelectric element 45 is connected to the residual vibration detection circuit 324. The residual vibration detection circuit 324 generates a detection signal BD based on the residual vibrations Rv (that is, the back electromotive force BEF) produced by the Mth instance of ejection driving. The control unit 60 calculates the characteristic value Cv based on the detection signal BD generated by the residual vibration detection circuit 324 (step S202 to step S204), and determines the number of ejection drivings N carried out in the second flushing operation based on the calculated characteristic value Cv (step S205). A table TBL3, such as that shown in FIG. 15, is used in the determination of the number of ejection drivings N. As shown in FIG. 15, in the table TBL3, respective numerical values for the characteristic value Cv and the number of drivings N (ejection amount) are associated with each other. Each number N is set in advance, experimentally or statistically, so that the thickened components of ink having each characteristic value Cv are sufficiently discharged. In the same manner as step S101 to step S105 in the first embodiment, after the number of drivings N has been determined, the second flushing operation (N ejection drivings), the obtainment of the detection signal BD, the calculation of the characteristic value Cv, and the correction of the driving signal COM in this order are executed (step S206 to step S210). After the flow of operations shown in FIG. 14 ends, the next printing period RDR begins.

In a configuration where the amount of ink that is ejected during flushing operations (that is, the number of drivings N) is constant regardless of the characteristic value Cv of the ink, there is a chance that the flushing operations will not be executed appropriately. For example, if the ejection amount (that is, the number of drivings N) is constant despite a drop in the characteristic value Cv (that is, an increase in the viscosity), there is a chance that the thickened components of the ink will not be sufficiently discharged. On the other hand, if the ejection amount (that is, the number of drivings N) is constant despite a rise in the characteristic value Cv (that is, a decrease in the viscosity), there is a chance that an excessive amount of ink will be ejected. According to the configuration of the second embodiment, the characteristic value Cv (the viscosity of the ink) is calculated based on the residual vibrations Rv produced by the first flushing operation, and an amount of ink based on that characteristic value Cv is discharged in the second flushing operation. Accordingly, too much or too little ink can be prevented from being discharged in the flushing operations.

### Third Embodiment

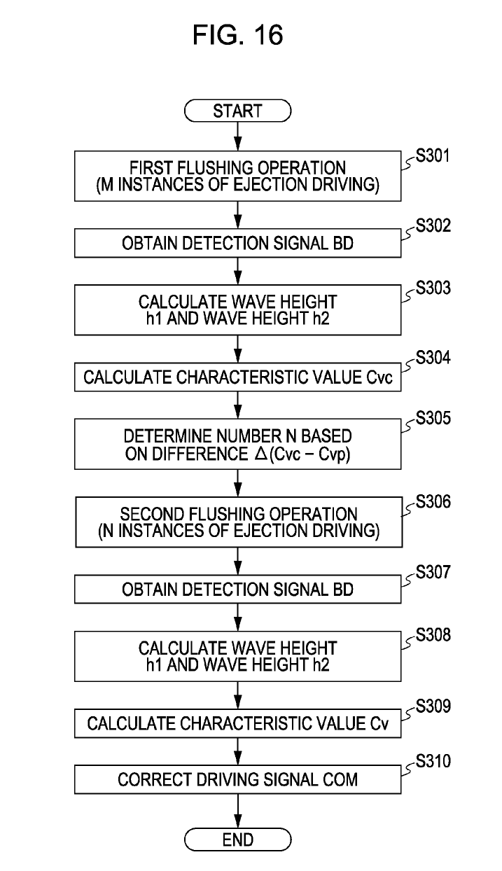

FIG. 16 is an example of a flow of operations through which the control unit 60 according to a third embodiment corrects the driving signal COM in the adjustment period RFL. As in step S201 to step S204 in the second embodiment, when the printing period RDR ends and the adjustment period RFL starts, the control unit 60 executes the first flushing operation, and calculates a characteristic value Cvc in the current printing period RDR based on the residual vibrations Rv produced by the Mth ejection driving (step S301 to step S304). The control unit 60 determines the number N of ejection drivings in the second flushing operation in accordance with a difference Δ (Δ=Cvc−Cvp) between the current characteristic value Cvc and a characteristic value Cvp calculated after the flushing operation (the first flushing operation or the second flushing operation) performed in the previous adjustment period RFL (step S305). Specifically, in the case where the difference Δ exceeds a threshold Th, the control unit 60 sets a greater value than any of the number of drivings N defined in the table TBL3 (for example, 200) as the number N, whereas in the case where the difference Δ is less than or equal to the threshold Th, the value corresponding to the current characteristic value Cvc is set as the number N using the table TBL3. In the same manner as step S206 to step S210 in the second embodiment, after the number of drivings N has been determined, the second flushing operation (N ejection drivings), the obtainment of the detection signal BD, the calculation of the characteristic value Cv, and the correction of the driving signal COM in this order are executed (step S306 to step S310). The characteristic value Cvc of the current adjustment period RFL calculated in step S304 or the characteristic value Cv calculated in step S309 is stored in the storage unit 62, and is used as the characteristic value Cvp in the next adjustment period RFL. After the flow of operations shown in FIG. 16 ends, the next printing period RDR begins.

With a configuration that determines the amount of ink to be ejected in the flushing operations based only on the characteristic value Cv in the current adjustment period RFL, there is a chance, in the case where the ink within the pressure chambers 50 has suddenly thickened between the previous adjustment period RFL and the current adjustment period RFL, that the thickened components of the ink cannot be sufficiently discharged through the flushing operations in the current adjustment period RFL. However, according to the configuration of the third embodiment, the amount of ink ejected through the flushing operations in the current adjustment period RFL is determined based on the result of comparing the characteristic value Cvp in a past (the previous) adjustment period RFL and the characteristic value Cvc in the current adjustment period RFL (that is, the difference Δ). Accordingly, it is easier to discharge a sufficient amount of thickened components from within the pressure chambers 50, even in the case where the ink within the pressure chambers 50 has suddenly thickened. Accordingly, the characteristic value Cv of the ink corresponding to the reduction in effect by the thickening of the ink can be calculated, and thus the driving signal COM can be corrected in an appropriate manner.

### Variations

Many variations can be made on the aforementioned embodiments. Examples of specific variations will be described hereinafter. Note that two or more variations may be selected as desired from the examples given below and combined as appropriate.

### Variation 1

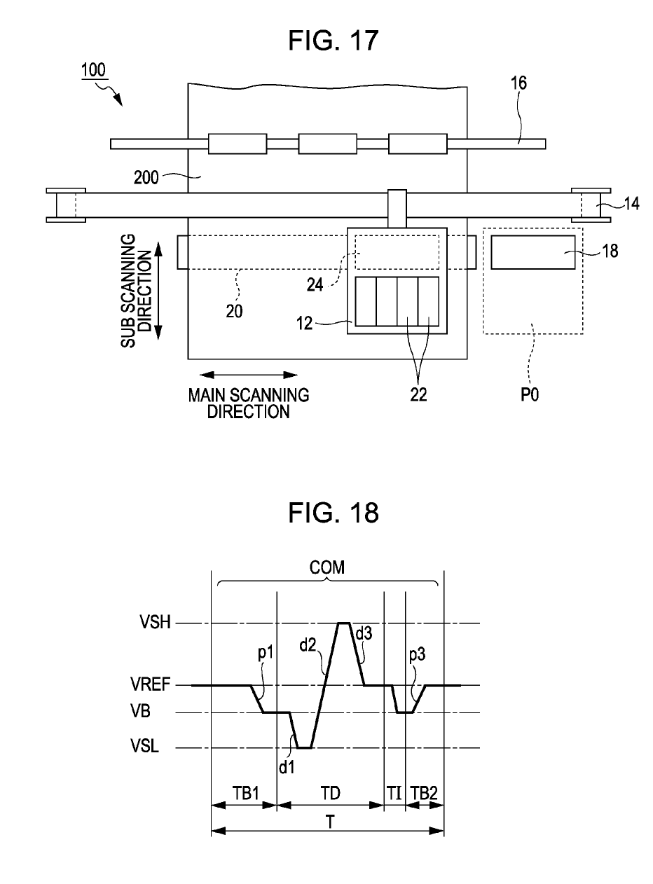

As shown in FIG. 17, the printing apparatus 100 may include a heating device (a heater) 20. The heating device 20 opposes the recording head 24 during the back-and-forth movement. The heating device 20 heats and dries the ink that has been ejected onto the recording paper 200 based on control performed by the control unit 60. The ink within the pressure chambers 50 of the recording head 24 is heated by the heating device 20 during the back-and-forth movement, resulting in frequent changes of the characteristics such as temperature or the like. Accordingly, the effects achieved by the configurations of the aforementioned embodiments, which correct the driving signal COM based on the characteristics of the ink, are even more prominent.

### Variation 2

Although the driving signal COM generated by the driving signal generation unit 64 is the same in the printing period RDR and the adjustment period RFL in the aforementioned embodiments, the driving signal COM may differ between the printing period RDR and the adjustment period RFL. For example, a driving signal COM having only the ejection pulse PD may be generated by the driving signal generation unit 64 in the adjustment period RFL. Furthermore, although the ejection pulse PD from the printing period RDR is also used in the flushing operations, the driving signal generation unit 64 may generate a driving signal COM having a dedicated pulse for ejection driving in the flushing operations.

Although a single type of driving signal COM is applied to the recording head 24 in the aforementioned embodiments, a configuration that uses a plurality of types of driving signals COM in the driving of the respective piezoelectric elements 45 (for example, a configuration in which the ejection pulse PD and the minute vibration pulse PB are set as individual driving signals) can also be employed. Furthermore, the respective pulses (PD, PB) in the driving signal may have any waveform, and may, for example, be square pulses.

### Variation 3

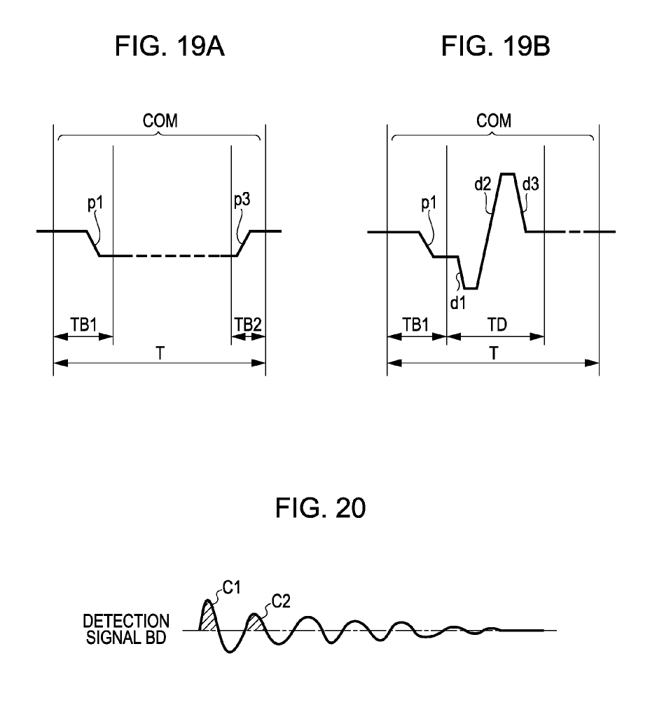

Although the ejection pulse PD and the minute vibration pulse PB are provided in series within the driving signal COM in the aforementioned embodiments, a waveform that causes the minute vibration driving to be executed (a minute vibration waveform) may, for example, be split up between a period TB1 and a period TB2, as shown in FIG. 18. With this driving signal COM, the minute vibration waveform shown in FIG. 19A is supplied to the piezoelectric element 45 by the driving circuit 322 selecting the period TB1 and the period TB2, whereas an ejection waveform shown in FIG. 19B is supplied to the piezoelectric element 45 by the driving circuit 322 selecting the period TB1 and a period TD. Note that the waveform that causes the ejection driving to be executed (the ejection waveform) may be divided up into a plurality of periods. As described thus far, any waveform may be used in the driving signal COM as long as it is a waveform that can produce an ejection waveform and a minute vibration waveform by the driving circuit 322 selecting one or more periods within the driving signal COM.

### Variation 4

Although the aforementioned embodiments describe an example in which the ratio of the wave heights of two adjacent peaks within the detection signal BD (the residual vibrations Rv) is used as the characteristic value Cv, any given value that reflects the characteristics of the ink can be used as the characteristic value Cv. For example, the ratio of integrated values (C1 and C2, in FIG. 20) of signal levels in segments whose signal levels exceed a predetermined value in the detection signal BD (the residual vibrations Rv) may be used as the characteristic value Cv.

### Variation 5

Although the aforementioned embodiments describe the control unit 60 determining the correction value S based on the characteristic value Cv using the table TBL1 and the table TBL2, the control unit 60 may calculate the correction value S based on a function that takes the characteristic value Cv as a variable. In addition, the control unit 60 may calculate the correction value S directly from the detection signal BD (the residual vibrations Rv), without calculating the characteristic value Cv. Furthermore, although the aforementioned embodiments describe the control unit 60 determining the ejection driving number N in the flushing operations in accordance with the table TBL3, the control unit 60 may calculate the number N based on a function that takes the characteristic value Cv as a variable. According to this configuration, the correction value S or ejection driving number N can be continuously determined for the characteristic value Cv that changes continuously. However, the processing load on the control unit 60 will increase if operations are executed based on a function. Accordingly, it is preferable, from the standpoint of reducing the processing load, for the correction value S and the number N to be determined using tables.

### Variation 6

Although the aforementioned embodiments describe determining the correction value S based on the characteristic value Cv using the table TBL1 and the table TBL2, the correction value S may be determined using a single table in which the characteristic values Cv and the correction values S are directly associated with each other. According to this configuration, the correction value S is determined using a single table, which simplifies the configuration. However, in the case where the table TBL2 has already been set experimentally or statistically, a configuration in which the table TBL2 is carried over and combined with the table TBL1 is convenient.

### Variation 7

In the aforementioned embodiments, the control unit 60 finds the correction value S based on the characteristic value Cv, and the waveform of the driving signal COM generated by the driving signal generation unit 64 is changed. However, the configuration may be such that the driving signal generation unit 64 is capable of generating a plurality of driving signals COM, the control unit 60 generates an identification signal I that identifies a single driving signal COM based on the characteristic value Cv, and one of the plurality of driving signals COM is selected and generated by the driving signal generation unit 64 based on the identification signal I.

### Variation 8

Although the flushing operations are executed and the driving signal COM is corrected in each adjustment period RFL in the aforementioned embodiments, these operations may be executed in any given cycle. For example, the flushing operations may be executed and the driving signal COM corrected every predetermined number of adjustment periods RFL. Alternatively, the flushing operations may be executed in each adjustment period RFL, and the driving signal COM may be corrected every predetermined number of adjustment periods RFL.

### Variation 9

Although the third embodiment describes changing the amount of ink ejected (number of ejection drivings) in the second flushing operation based on the result of comparing the threshold Th and the difference Δ, the configuration may be such that a threshold Th2 that is lower than the threshold Th (for example, 0) is further provided and the amount of ink ejected in the case where the difference Δ is less than or equal to the threshold Th2 is 0 (in other words, the second flushing operation is not carried out). According to this configuration, the amount of ink ejected is 0 in the case where the ink has not thickened in the printing period RDR, and thus the amount of ink ejected in the adjustment period RFL can be reduced.

### Variation 10

Although the third embodiment describes calculating the difference Δ between the characteristic value Cv calculated after the second flushing operation (after the Nth ejection driving) in the adjustment period RFL immediate before the current adjustment period RFL (the previous adjustment period RFL) and the characteristic value Cv calculated after the first flushing operation (after the Mth ejection driving) in the current adjustment period RFL, a difference Δ between the characteristic value Cv calculated after a flushing operation (a first flushing operation or a second flushing operation) in an adjustment period RFL prior to the previous adjustment period RFL and the characteristic value Cv in the current adjustment period RFL calculated in the manner described above may be calculated instead. In other words, the amount of ink ejected in the second flushing operation can be changed based on the difference Δ between the characteristic value Cv in any past adjustment period RFL and the characteristic value Cv in the current adjustment period RFL.

### Variation 11

Although the aforementioned embodiments describe a serial-type printing apparatus 100 that moves the carriage 12 in which the recording head 24 is mounted, the invention can also be applied in a line-type printing apparatus 100 in which a plurality of nozzles 52 are arranged so as to oppose the entirety of the recording paper 200 in the width direction thereof. In a line-type printing apparatus 100, the recording head 24 is fixed, and images are recorded onto the recording paper 200 by ejecting ink droplets from the nozzles 52 while transporting the recording paper 200. As can be understood from these descriptions, the recording head 24 itself may be mobile or fixed in the invention.

### Variation 12

The printing apparatus 100 according to the aforementioned embodiments can be employed in a variety of devices, such as plotters, facsimile machines, copiers, and so on. Most notably, the application of the liquid ejecting apparatus according to the invention is not limited to the printing of images. For example, a liquid ejecting apparatus that ejects solutions of various coloring materials can be used as a manufacturing apparatus that forms color filters used in liquid-crystal display devices. Meanwhile, a liquid ejecting apparatus that ejects a conductive material in liquid form can be used as an electrode manufacturing apparatus that forms electrodes in display devices such as electroluminescence (EL) display devices, field emission displays (FEDs), and so on. Finally, a liquid ejecting apparatus that ejects a bioorganic matter solution can be used as a chip manufacturing apparatus that manufactures biochemical devices (biochips).

The entire disclosure of Japanese Patent Application No. 2011-071863, filed Mar. 29, 2011 is expressly incorporated by reference herein.

What is claimed is:

1. A liquid ejecting apparatus comprising:
a liquid ejecting head, including a pressure chamber filled with a liquid and a pressure generation element that causes a pressure of the liquid within the pressure chamber to fluctuate, that is capable of executing ejection driving that ejects the liquid from a nozzle based on the pressure fluctuation in the liquid within the pressure chamber;
a driving waveform generation unit that generates a driving waveform for executing the ejection driving;
a control unit that causes the liquid ejecting head to execute a flushing operation that discharges the liquid within the pressure chamber; and
a residual vibration detection unit that detects a residual vibration in the liquid within the pressure chamber,
wherein the control unit corrects the driving waveform based on the residual vibration produced by the flushing operation.

2. The liquid ejecting apparatus according to claim 1,
wherein the control unit calculates a characteristic value corresponding to a characteristic of the liquid based on the residual vibration produced by the flushing operation, and corrects the driving waveform based on the characteristic value.

3. The liquid ejecting apparatus according to claim 2,
wherein the control unit calculates a first characteristic value based on the residual vibration produced by a first flushing operation, causes the execution of a second flushing operation that ejects the liquid of an amount based on the first characteristic value, calculates a second characteristic value based on the residual vibration produced by the second flushing operation, and corrects the driving waveform based on the second characteristic value.

4. The liquid ejecting apparatus according to claim 3,
wherein the control unit:
causes the flushing operation to be executed every adjustment period, the adjustment period being a different period from a period in which the liquid ejecting head ejects the liquid onto a recording medium; and
determines the amount of liquid to be ejected in the second flushing operation of the current adjustment period in accordance with a result of comparing the first characteristic value or the second characteristic value of a previous adjustment period with the first characteristic value of the current adjustment period.

5. The liquid ejecting apparatus according to claim 2,
wherein the control unit specifies a temperature of the liquid based on the characteristic value and corrects the driving waveform based on the temperature.

6. The liquid ejecting apparatus according to claim 1, further including:
a heating device that heats the ejected liquid.

7. A control method for a liquid ejecting apparatus,
wherein the liquid ejecting apparatus includes:
a liquid ejecting head, having a pressure chamber filled with a liquid and a pressure generation element that causes a pressure of the liquid within the pressure chamber to fluctuate, that is capable of executing ejection driving that ejects the liquid from a nozzle based on the pressure fluctuation in the liquid within the pressure chamber;
a driving waveform generation unit that generates a driving waveform for executing the ejection driving;
a control unit that causes the liquid ejecting head to execute a flushing operation that discharges the liquid within the pressure chamber; and
a residual vibration detection unit that detects a residual vibration in the liquid within the pressure chamber, and
the control method comprises:
correcting the driving waveform based on the residual vibration produced by the flushing operation.
